(19) United States
(12) Patent Application Publication
(10) Pub. No.: US 2002/0071277 A1
(43) Pub. Date: Jun. 13, 2002

(54) System and method for capturing an image

(76) Inventors: Thad E. Starner, Atlanta, GA (US); Maribeth Gandy, Atlanta, GA (US); Daniel Ashbrook, Atlanta, GA (US); Jake Alan Auxier, Atlanta, GA (US); Rob Melby, Marietta, GA (US); James Fusia II, Dahlonega, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 09/927,193

(22) Filed: Aug. 10, 2001

Related U.S. Application Data
(60) Provisional application No. 60/224,826, filed on Aug. 12, 2000.
(60) Provisional application No. 60/300,989, filed on Jun. 26, 2001.

(51) Int. Cl. F21V 14/00

(52) U.S. Cl. 362/276

(57) ABSTRACT

The image-capturing system and method relates to the field of optics. One embodiment of the image-capturing system comprises a light-emitting device that emits light on an object; an image-forming device that forms one or more images due to a light that is reflected from the object; and a processor that analyzes motion of the object to control electrical devices, where the light-emitting device and the image-forming device are configured to be portable.

### CROSS-REFERENCE TO RELATED APPLICATION(S)

This application claims priority to copending U.S. provisional application entitled, “Gesture pendant: A wearable computer vision system for home automation and medical monitoring,” having serial no. 60/224,826, filed Aug. 12, 2000, which is entirely incorporated herein by reference. This application also claims priority to copending U.S. provisional application entitled, “Improved Gesture Pendant,” having serial no. 60/300,989, filed Jun. 26, 2001, which is entirely incorporated herein by reference.

### TECHNICAL FIELD

The present invention is generally related to the field of optics and more particularly, is related to a system and method for capturing an image.

### BACKGROUND OF THE INVENTION

Currently there are known command-and-control interfaces that help control electrical devices such as, but not limited to, televisions, home stereo systems, and fans. Such known command-and-control interfaces comprise a remote control, a portable touch screen, a wall panel interface, a phone interface, a speech recognition interface and other similar devices.

There are a number of inadequacies and deficiencies in the known command-andcontrol interfaces. The remote control has small, difficult to push buttons and cryptic text labels that are hard to read even for a person with no loss of vision or motor skills. Additionally, a person generally has to carry the remote control to operate the remote control. The portable touch screen also has small, cryptic labels that are difficult to recognize and push, especially for the elderly and people with disabilities. Moreover, the portable touch screen is dynamic and hard to learn since its display and interface changes depending on the electrical device to be controlled.

An interface designed into a wall panel, the wall panel interface, generally requires a user to approach the location of the wall panel physically. A similar restriction occurs with phone interfaces. Furthermore, the phone interface comprise small buttons that render it difficult for a user to read and use the phone interface, especially a user who is elderly or has disabilities.

The speech recognition interface also involves a variety of problems. First, in a place with more than one person, the speech recognition interface creates disturbance when the people speak simultaneously. Second, if a user that is using the speech recognition interface, is watching television or listening to music, the user has to speak loudly to overcome the noise that the television or music creates. The noise can also create errors in the recognition of speech by the speech recognition interface. Finally, using the speech recognition interface is not graceful. Imagine being among guests at a dinner party. A user should excuse himself/herself to speak into the speech recognition interface, for instance, to lower the level of light in a room in which the guests are sitting. Alternatively, the user can speak into the interface while being in the same location as that of the guests, however, that would be awkward, inconvenient, and disruptive.

Yoshiko Hara, CMOS Sensors Open Industry's Eyes to New Possibilities, EE Times, Jul. 24, 1998, and http://www.Toshiba.com/news/980715.htm, July 1998, illustrates a Toshiba motion processor. Each of the above references is incorporated by reference herein in its entirety. The Toshiba motion processor controls various electrical devices by recognizing gestures that a person makes. The Toshiba motion processor recognizes gestures by using a camera and infrared light-emitting diodes. However, the camera and the infrared light-emitting diodes in the Toshiba motion processor are in a fixed location, thereby making it inconvenient, especially for an elderly or a disabled user, to use the Toshiba motion processor. The inconvenience to the user results from the limitation that the user has to physically be in front the camera and the infrared light-emitting diodes, to input gestures into the system. Even if a user is not elderly or has no disability, it is inconvenient for the user to physically move in front of the camera each time the user wants to control an electrical device, such as, a television or a fan.

Lastly, some known monitoring systems include an infrastructure of cameras and microphones in a ceiling, and an infrastructure of sensors on the floor. However, these monitoring systems experience problems due to occlusion and lighting since natural light and other light interferes with the light that is reflected from an object that the monitoring systems monitor.

Thus, a need exists in the industry to overcome the above-mentioned inadequacies and deficiencies.

### SUMMARY OF THE INVENTION

The present invention provides a system and method for capturing an image of an object.

Briefly described, in architecture, an embodiment of the system, among others, can be implemented with the following: a light-emitting device that emits light on an object; an image-forming device that forms one or more images due to a light that is reflected from the object; and a processor that analyzes motion of the object to control electrical devices, where the light-emitting device and the image-forming device are configured to be portable.

The present invention can also be viewed as providing a method for capturing an image of an object. In this regard, one embodiment of such a method, among others, can be broadly summarized by the following steps: emitting light on an object; forming one or more images due to a light reflected from the object; and processing data that corresponds to the one or more images to control electrical devices, where the step of emitting light is performed by a light-emitting device that is configured to be portable, and the step of forming the one or more images of the object is performed by an image-forming device that is configured to be portable.

Other features and advantages of the present invention will be or become apparent to one with skill in the art upon examination of the following drawings and detailed description. It is intended that all such additional features and advantages be included within this description, be within the scope of the present invention, and be protected by the accompanying claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a block diagram of an embodiment of an image-capturing system.

FIG. 2 is a block diagram of another embodiment of the image-capturing system of FIG. 1.

FIG. 3 is a block diagram of another embodiment of the image-capturing system of FIG. 1.

FIG. 4A is a block diagram of another embodiment of the image-capturing system of FIG. 1.

FIG. 4B is an array of an image of light-emitting diodes of the image-capturing system of FIG. 4A.

### DETAILED DESCRIPTION OF THE PREFERRED EMBODIMENTS

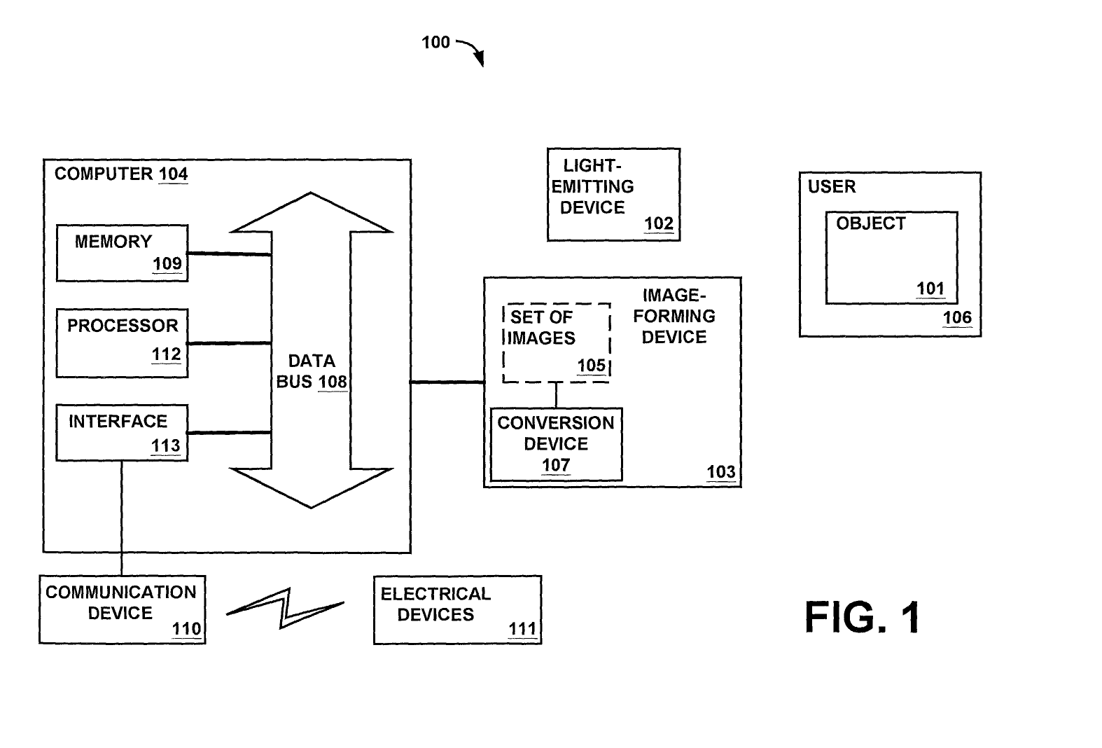

FIG. 1 is a block diagram of an embodiment of an image-capturing system 100. The image-capturing system 100 comprises a light-emitting device 102, an image-forming device 103, and a computer 104. The light-emitting device 102 can be any device including, but not limited to, light-emitting diodes, bulbs, tube lights and lasers. An object 101 that is in front of the light-emitting device 102 and the image-forming device 103, can be an appendage such as, for instance, a foot, a paw, a finger, or preferably a hand of a user 106. The object 101 can also be a glove, a pin, a pencil, and or any other item that the user 106 is holding. The user 106 can be, but is not limited to, a machine, a robot, a human being, or an animal. The image-forming device 103 comprises any device that forms a set of images 105 of all or part of the object 101 and known to people having ordinary skill in the art. For instance, the image-forming device 103 comprises one of a lens, a plurality of lenses, a mirror, a plurality of mirrors, a black and white camera, or a colored camera. Additionally, the image-forming device 103 can also comprise a conversion device 107 such as, but not limited to, a scanner or a charge-coupled device.

The computer 104 comprises a data bus 108, a memory 109, a processor 112, and an interface 113. The data bus 108 can be, for example, but not limited to, one or more buses or other wired or wireless connections, as is known in the art. The memory 109 can include any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory 109 may incorporate electronic, magnetic, optical, and/or other types of storage media. Note that the memory 109 can have a distributed architecture, where various components are situated remote from one another, but can be accessed by the processor 112.

The interface 113 may have elements, which are omitted for simplicity, such as controllers, buffers (caches), drivers, repeaters, and transceivers, to enable communications. Further, the interface 113 may include address, control, and/or data connections to enable appropriate communications among the aforementioned components comprised in the computer 104.

The processor 112 can be any device that is known to people having ordinary skill in the art and that processes information. For instance, the processor 112 can be a digital signal processor, any custom made or commercially available processor, a central processing unit, an auxiliary processor, a semi-conductor based processor in the form of a micro-chip or chip set, a microprocessor or generally any device for executing software instructions. Examples of suitable commercially available microprocessors are as follows: a PA-RISC series microprocessor from Hewlett Packard Company, an 80X86 or Pentium series microprocessor from Intel Corporation, a power PC microprocessor from IBM, a sparc microprocessor from Sun Microsystems, Inc., or a 68 XXX series microprocessor from Motorola Corporation.

The computer 104 preferably is located at the same location as the light-emitting device 102, the image-forming device 103, and the user 106. For instance, the computer 104 can be located in a pendant or a pin that comprises the light-emitting device 102 and the image-forming device 103, and the pendant or the pin can be placed on the user 106. The pendant can be around the user's 106 neck and the pin can be placed on his/her chest. Alternatively, the computer 104 can be coupled to the image-forming device 103 via a network such as a public service telephone network, integrated service digital network, or any other wired or wireless network.

When the computer 104 is coupled to the image-forming device 103 via the network, a transceiver can be located in the light-emitting device 102 or the image-forming device 103 or in a device such as a pendant that comprises the image-forming device 103 and the light-emitting device 102. The transceiver can send data that corresponds to a set of images 105 to the computer 104 via the network. It should be noted that the light-emitting device 102, the image-forming device 103, and preferably the computer 104 are portable and therefore, can move with the user 106. For example, the light-emitting device 102, the image-forming device 103, and preferably the computer 104 can be located in a pendant that the user 106 can wear, thereby rendering the image-capturing system 100 capable of being displaced along with the user 106. Alternatively, the light-emitting device 102, the image-forming device 103, and preferably the computer 104 can be located in a pin, or any device that may be associated with the user 106 or the user's 106 clothing, and simultaneously move with the user 106. For example, the light-emitting device 102 is located in a hat, while the image-forming device 103 and the computer 104 can be located in a pin or a pendant. In yet another alternative embodiment of the image-capturing system 100, the light-emitting device is located on the object 101 of the user 106, and emits light on the object 101. For instance, light-emitting diodes can be located on a hand of the user 106.

The light-emitting device 102 emits light on the object 101. The light can be, but is not limited to, infrared light such as near and far infrared light, laser light, white light, violet light, indigo light, blue light, green light, yellow light, orange light, red light, ultra violet light, microwaves, ultrasound waves, radio waves, X-rays, cosmic rays, or any other frequency that can be used to form the set of images 105 of the object 101. The frequency of the light should be such that the light can be incident on the object 101 without harming the user 106. Moreover, the frequency should be such that a light is reflected from the object 101 due to the light emitted on the object 101.

The object 101 reflects rays of light, some of which enter the image-forming device 103. The image-forming device 103 forms the set of images 105 that comprise one or more images of all or part of the object 101. The conversion device 107 obtains the set of images 105 and converts the set of image 105 to data that corresponds to the set of images 105. The conversion device 107 can be, for instance, a scanner that scans the set of images 105 to obtain the data that corresponds to the set of images 105.

Alternatively, the conversion device 107 can be a charge-coupled device that is a light-sensitive integrated circuit that stores and displays the data that corresponds to an image of the set of images 105 in such a way that each pixel in the image is converted into an electrical charge the intensity of which is related to a color in a color spectrum. For a system supporting 65,535 colors, there will be a separate value for each color that can be stored and recovered. Charged-coupled devices are now commonly included in digital still and video cameras. They are also used in astronomical telescopes, scanners, and bar code readers. The devices have also found use in machine vision for robots, in optical character recognition (OCR), in the processing of satellite photographs, and in the enhancement of radar images, especially in meteorology.

In an alternative embodiment of the image-capturing system 100, the conversion device 107 is located outside the image-forming device 103, and coupled to the image-forming device 103. Moreover, the computer 104 is coupled to the conversion device 107 via the interface 113. If the conversion device 107 is located outside the image-forming device 103, the computer 104 and the conversion device 107 can be at the same location as the light-emitting device 102, and the image-forming device 103, such as for instance, in a pendant or a pin that comprises the light-emitting device 102 and the image-forming device 103. Alternatively, if the conversion device 107 is located outside the image-forming device 103, the computer 104 and the conversion device 107 can be coupled to the image-forming device 103 via the network. In another alternative embodiment of the image-capturing system 100, if the conversion device 107 is located outside the image-forming device 103, the computer 104 is coupled to the conversion device 107 via the network, where the conversion device 107 is located at the same location as the light-emitting device 102, and the image-forming device 103. Furthermore, the conversion device 107 is coupled to the image-forming device 103.

The data is stored in the memory 109 via the data bus 108. The processor 112 then processes the data by executing a program that is stored in the memory 109. The processor 112 can use hidden Markov models (HMMs) to process the data to send commands that control various electrical devices 111. L. Baum, An inequality and associated maximization technique in statistical estimation of probabilistic functions of Markov processes, Inequalities, 3:1-8, 1972; X. Huang, Y. Ariki, and M.A. Jack, Hidden Markov Models for Speech Recognition, Edinburgh University Press, 1990; L.R. Rabiner and B.H. Juang, An introduction to hidden Markov models, IEEE ASSP Magazine, pages 4-16, January 1986; T. Starner, J. Weaver, and A. Pentland, Real-time American Sign Language recognition using desk and wearable computer-based video, IEEE Trans. Patt. Analy. and Mach. Intell., 20(12), December 1998; and S. Young, HTK: Hidden Markov Model Toolkit V1.5, Cambridge Univ. Eng. Dept. Speech Group and Entropic Research Lab, Inc., Washington D.C., 1993, describe HMMs. Each of the above references is incorporated by reference herein in its entirety.

The processor 112 sends the commands to the interface 113 via the data bus 108. The commands correspond to the data and are further transmitted to a communication device 110. The communication device 110 controls the electrical devices 111. The communication device 110 can be, for instance, a wireless radio frequency system, a transceiver, the light-emitting device 102, an X10 box, or an infrared light-emitting device such as a remote control. Alternatively, the processor 112 can directly send the commands via the interface 113 to the electrical devices 111, thereby controlling the electrical devices 111. The electrical devices 111 include, but are not limited to, a light, a car stereo system, a radio, a television, a phone, a grill, a computer, a fan, a door, a window, a stereo, a refrigerator, an oven, a dishwasher, washers and dryers, answering machines, phones, a garage door, a hot plate, window blinds, night lights, doors, safe combinations, electric blankets, fax machines, printers, wheelchairs, adjustable beds, intercoms, chair lifts, jacuzzis, digital portraits, ATMs, faucets, freezers, cellular phones, microscopes, and electronic readers. The electrical devices 111 also include a home entertainment system such as a DVD player, a VCR, and a stereo. Moreover, the electrical devices 111 comprise heating ventilation and air conditioning systems (HVAC) such as a fan, a thermostat; and security systems such as door locks, window locks, and motion sensors.

The user 106 moves the object 101 to control the electrical devices 111. For instance, the user 106 can simply raise or lower a flattened hand to control the level of light and can control the volume of a stereo by raising or lowering a pointed finger. If the light-emitting device 102, the image-forming device 103, and the computer 104 are comprised in a device such as a pendant or a pin that can move with the user 106, the image-capturing system 100 can be used to control devices in an office, in a car, on a sidewalk, or at a friend's house. Furthermore, the image-capturing system 100 also allows the user 106 to maintain his/her privacy since the user 106 can edit or delete, thereby controlling images in the set of images 105. For instance, the user 106 can access the memory 109 and delete the set of images 105 from the memory 109.

The processor 112 recognizes mainly two types of gestures. Gestures are movements of the object 101. The two types of gestures are control gestures and user-defined gestures. Control gestures are those that are needed for continuous output to the electrical devices 111, for example, a volume control on a stereo. Moreover, control gestures are simple because they need to be interactive and are generally used more often.

The processor 112 implements an algorithm such as a nearest neighbor algorithm to recognize the control gestures. Therrien, Charles, W, “Decision Estimation and Classification,” John Wiley and Sons Inc., 1989, describes the nearest neighbor algorithm, and is incorporated by reference herein in its entirety. The processor 112 recognizes the control gestures by determining displacement of the control gestures. The processor 112 determines the displacement of the control gestures by continual recognition of movement of the object 101, represented by movement between images comprised in the set of images 105. Specifically, the processor 112 calculates the displacement by computing eccentricity, major and minor axes, the distance between a centroid of a bounding box of a blob and a centroid of the blob, and angle of the two centroids. The blob surrounds an image in the set of images 105 and the bounding box surrounds the blob. The blob is an ellipse for twodimensional images in the set of images 105 and is an ellipsoid for three-dimensional images in the set of images 105. The blob can be of any shape or size, or of any dimension known to people having ordinary skill in the art. Examples of control gestures include, but are not limited to, horizontal pointed finger up, horizontal pointed finger down, vertical pointed finger left, vertical pointed finger right, horizontal flat hand down, horizontal flat hand up, open palm hand up, and open palm hand down. Berthold K. P. Horn, Robot Vision, The MIT Press (1986) describes the above-mentioned process of determining the displacement of the control gestures, and is incorporated by reference herein in its entirety.

User-defined gestures provide discrete output for a single gesture. In other words, the user-defined gestures are intended to be one or two-handed discrete actions through time. Moreover, the user-defined gestures can be more complicated and powerful since they are generally used less frequently than the control gestures. Examples of user-defined gestures include, but are not limited to, door lock, door unlock, fan on, fan off, door open, door close, window up, and window down. The processor 112 uses the HMMs to recognize the user-defined gestures.

In an embodiment of the image-capturing system 100, the user 106 defines different gestures for each function, for example, if the user 106 wants to be able to control volume on a stereo, level of a thermostat, and the level of illumination, the user 106 defines three separate gestures. In another embodiment of the image-capturing system 100 of FIG. 1, the user 106 uses speech in combination with the gestures. The user 106 speaks the name of one of the electrical devices 111 that the user 106 wants to control, and then gestures to control that electrical device. In this manner, the user 106 can use the same gesture to control, for instance, volume on the stereo, the thermostat, and the light. This results in fewer gestures that the user 106 needs to use as compared to the user 106 using separate gestures to control each of the electrical devices 111.

In another embodiment of the image-capturing system 100, the image-capturing system 100 comprises a transmitter that is placed on the user 106. The user 106 aims his/her body to one of the electrical devices 111 that the user 106 wants to control so that the transmitter can transmit a signal to that electrical device. The user 106 can then control the electrical device by making gestures. In this manner, the user 106 can use the same gestures to control any of the electrical devices 111 by first aiming his/her body towards that electrical device. However, if two of the electrical devices 111 are close together, the user 106 probably should use separate gestures to control each of the two electrical devices. Alternatively, if two of the electrical devices 111 are situated close to each other, fiducials such as, for instance, infrared light-emitting diodes, can be placed on both the electrical devices so that the image-capturing system 100 of FIG. 1 can easily discriminate between the two electrical devices. Thad Stamner, Steve Mann, Bradley Rhodes, Jeffrey Lavine, Jennifer Healey, Dane Kirsch, Rosalind W. Picard, Alex Pentland, Augmented Reality Through Wearable Computing (1997), describes fiducials and is incorporated by reference herein in its entirety.

In another embodiment of the image-capturing system 100 of FIG. 1, the imagecapturing system 100 can be implemented in combination with a radio frequency location system. C. Kidd and K. Lyons, Widespread Easy and Subtle Tracking with Wireless Identification Networkless Devices— WEST WIND: an Environmental Tracking System, October 2000, describes the radio frequency location system and is incorporated by reference herein in its entirety. In this embodiment, information regarding the location of the user 106 serves as a modifier. The user 106 moves to a location, for instance, a room that comprises one of the electrical devices 111 that the user 106 wants to control. The user 106 then gestures to control the electrical device in that location. However, if more than one of the electrical devices 111 are present at the same location, the user 106 uses different gestures to control the electrical devices 111 that are present at the same location.

In another embodiment of the image-capturing system 100, the light-emitting device 102 comprise lasers that point at one of the electrical devices 111, and the user 106 can make a gesture to control that electrical device. In another embodiment, the light-emitting device 102 is located on a eyeglass frames, brim of a hat, or any other items that the user 106 can wear. The user 106 wears one of the items, looks at one of the electrical devices 111, and then gestures to control that electrical device.

The processor 112 can also process the data, to monitor various conditions of the user 106. The various conditions include, but are not limited to, whether or not the user 106 has parkinson's syndrome, has insomnia, has a heart condition, lost control and fell down, is answering a doorbell, washing dishes, going to bath room periodically, is taking his/her medicine regularly, is taking higher doses of medicine than prescribed, is eating and drinking regularly, is not consuming alcohol to the level of being an alcoholic, or is performing tests regularly. The processor 112 can receive the data via the data bus 108, and perform a fast Fourier transform on the data to determine the frequency of, for instance, a pathological tremor. A pathological tremor is an involuntary, rhythmic, and roughly sinusoidal movement. The tremor can appear in the user 106 due to disease, aging, hypothermia, drug side effects, or effects of diabetes. A doctor or other medical personnel can then receive an indication of the frequency of the motion of the object 101 to determine whether or not the user 106 has a pathological tremor. Certain frequencies of the motion of the object 101, for instance, below 2 Hz, in a frequency domain, are ignored since they correspond to normal movement of the object 101. However, high frequencies of the object 101, referred to as dominant frequencies, correspond to a pathological tremor in the user 106.

The image-capturing system 100 can help detect essential tremors between 4-12 Hz, parkinsonian tremors from 3-5 Hz, and a determination of the dominant frequency of these tremors can be helpful in early diagnosis and therapy control of disabilities such as parkinson's disease, stroke, diabetes, arthritis, cerebral palsy, and multiple sclerosis.

Medical monitoring of the tremors can serve several purposes. Data that corresponds to the set of images 105 can simply be logged over days, weeks or months or used by a doctor as a diagnostic aid. Upon detecting a tremor or a change in the tremor, the user 106 might be reminded to take medication, or a physician or family member of the user 106 can be notified. Tremor sufferers who do not respond to pharmacological treatment can have a device such as a deep brain stimulator implanted in their thalamus. The device can help reduce or eliminate tremors, but the sufferer generally has to control the device manually. The data that corresponds to the set of images 105 can be used to provide automatic control of the device.

Another area in which tremor detection would be helpful is in drug trials. The user 106, if involved in drug trials, is generally closely watched for side effects of a drug, and the image-capturing system 100 can provide day-to-day monitoring of the user 106.

The image-capturing system 100 is activated in a variety of ways so that the image-capturing system 100 performs its functions. For instance, the user 106 taps the imagecapturing system 100 to turn it on and then taps it again to turn it off when the user 100 has finished making gestures. Alternately, the user 106 can hold a button located on the image-capturing system 100 to activate the system and then once the user 106 has finished making gestures, he/she can release the button. In another alternative embodiment of the image-capturing system 100, the user 106 can tap the image-capturing system 100 before making a gesture, and then tap the image-capturing system 100 again before making another gesture.

Furthermore, the intensity of the light-emitting device 102 can be adjusted to conform to an environment that surrounds the user 106. For instance, if the user 106 is in bright sunlight, the intensity of the light-emitting device 102 can be increased so that the light that the light-emitting device emits, can be incident on the object 101. Alternately, if the user is in dim light, the intensity of the light that the light-emitting device 102 emits, can be decreased. Photocells, if comprised in the light-emitting device 102, in the imageforming device 103, on the user 106, or on the object 101, can sense the environment to help adjust the intensity of the light that the light-emitting device 102 emits.

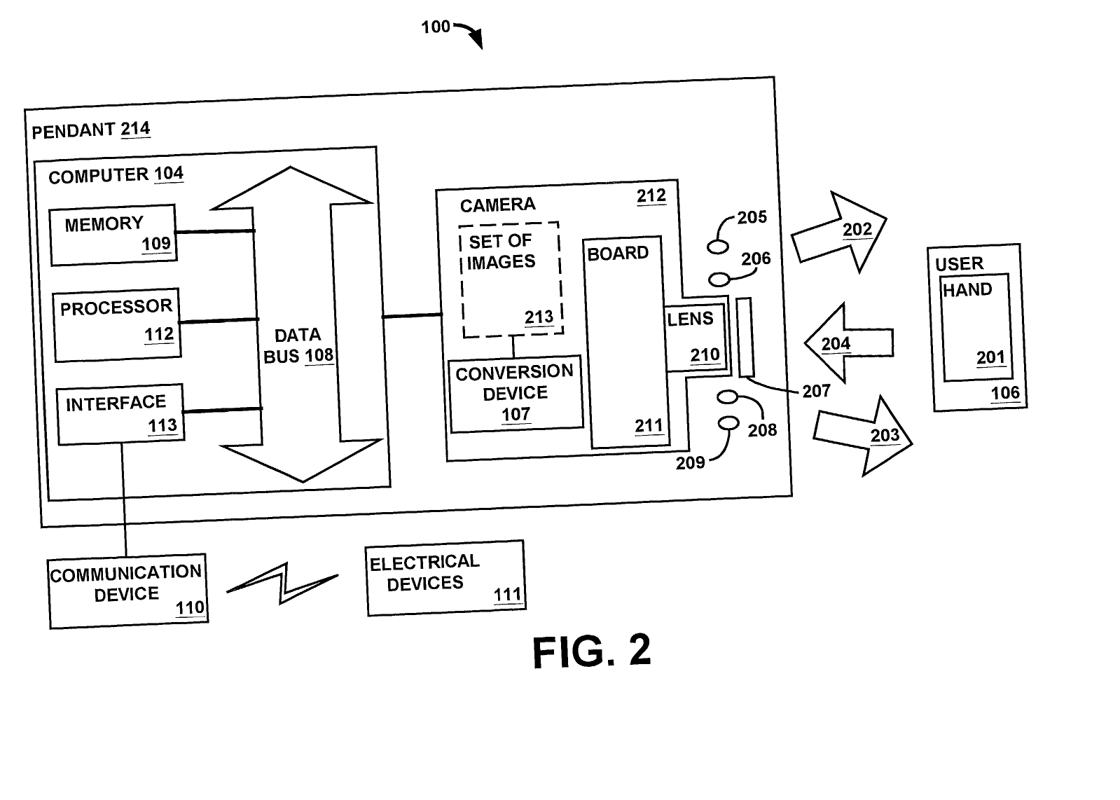

FIG. 2 is a block diagram of another embodiment of the image-capturing system 100 of FIG. 1. A pendant 214 comprises a camera 212, an array of light-emitting diodes 205, 206, 208, 209, a filter 207, and the computer 104. The camera 212 further comprises a board 211, a lens 210, and can comprise the conversion device 107. The board 211 is a circuit board, thereby making the camera 212 a board camera that is known by people having ordinary skill in the art. However, any other types of cameras can be used instead of the board camera. The camera 212 is a black and white camera that captures a set of images 213 in black and white. A black and white camera is used since processing of a colored image is computationally more expensive than processing of a black and white image. Additionally, most color cameras cannot be used in conjunction with the light-emitting diodes 205, 206, 208, and 209 since the color camera filters out infrared light. Any number of light-emitting diodes can be used.

Lights 202 and 203 that the light-emitting diodes 205, 206, 208, and 209 emit and light 204 that is reflected from a hand 201, is infrared light. Furthermore, the filter 207 can be any type of a passband filter that attenuates light having a frequency outside a designated bandwidth and that match frequencies of the light that the light-emitting diodes 205, 206, 208, and 209 emit. In this way, light that is emitted by the light-emitting diodes 205, 206, 208 and 209 emit may pass through to the filter 207 further to the lens 210.

In an alternative embodiment, the pendant 214 may not include the filter 207. The computer 104 can be situated outside the pendant 214 and be electrically coupled to the camera 212 via the network.

The light-emitting diodes 205, 206, 208 and 209 emit infrared light 202 and 204 that is incident on the hand 201 of the user 106. The infrared light 204 that is reflected from the hand 201 passes through the filter 207. The lens 210 receives the light 204 and forms the set of images 213 that comprises one or more images of all or part of the hand 201. The conversion device 107 performs the same functionality on the set of images 210 as that performed on the set of images 105 of FIG. 1. The processor 112 receives data that corresponds to the set of images 213 in the same manner as the processor 112 receives data that corresponds to the set of images 105 (FIG. 1). The processor 112 then computes statistics including, but not limited to, eccentricity of one or more blobs, the angle between the major axis of each blob and a horizontal, length of major and minor axis of each of the blobs, distance between a centroid of each of the blobs and center of a box that bounds each of the blobs, and an angle between a horizontal and a line between the centroid and center of the box. Each blob surrounds an image in the set of images 213. T. Starner, J. Weaver, and A. Pentland, Real-time American Sign Language recognition using desk and wearable computer-based video, EEE Trans. Patt. Analy. and Mach. Intell., 20(12), December 1998, describes an algorithm that the processor 112 uses to find each of the blobs and is incorporated by reference herein in its entirety. The statistics are used to monitor the various conditions of the user 106 or to control the electrical devices 111.

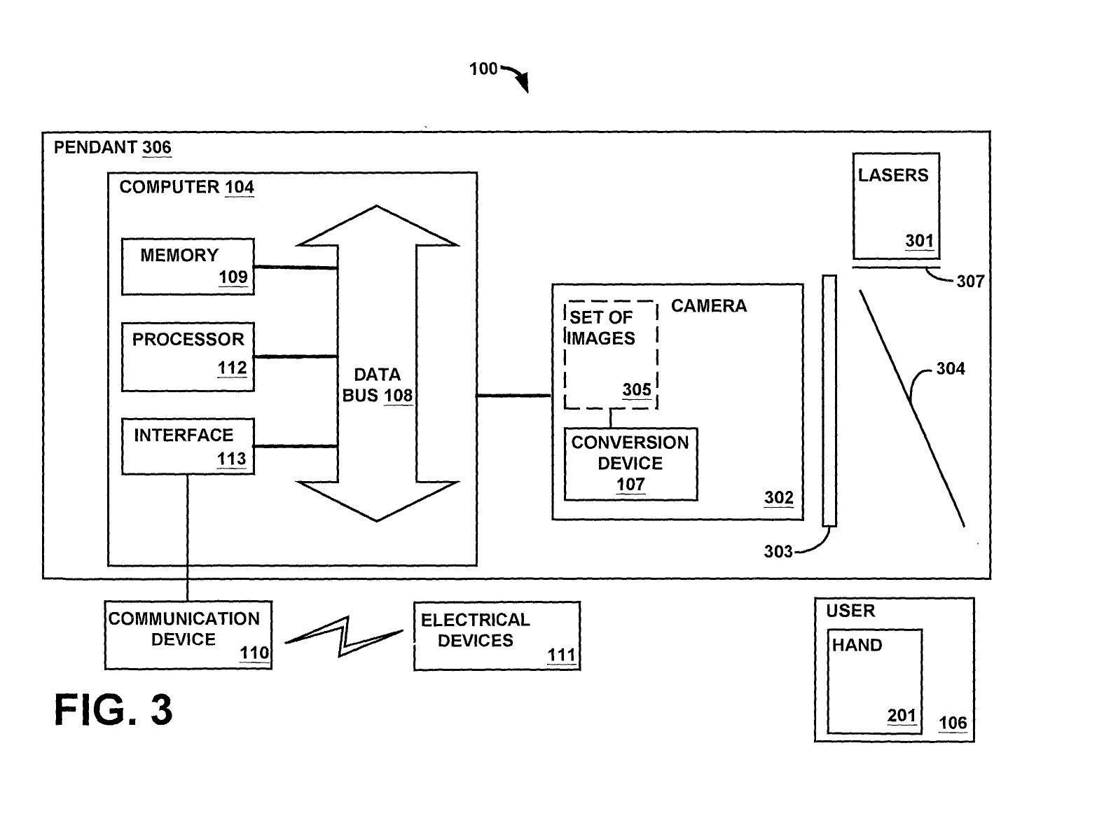

FIG. 3 is a block diagram of another embodiment of the image-capturing system of FIG. 1. A pendant 306 comprises a filter 303, a camera 302, a half-silvered mirror 304, lasers 301, a diffraction pattern generator 307, and preferably the computer 104. The filter 303 allows light of the same colors that lasers 301 emit, to pass through. For instance, the filter 303 allows red light to pass through if the lasers emit red light.

The camera 302 is preferably a color camera, a camera that produces color images. The camera 302 preferably comprises a pin hole lens and can comprise the conversion device 107. Moreover, the half-silvered mirror 304 is preferably located at a 135 degree angle counter-clockwise from a horizontal. However, the half-silvered mirror 304 is located at any angle to the horizontal. Nevertheless, geometry of the lasers 301 should match the angle. Furthermore, a concave mirror can be used instead of the half-silvered mirror 304.

The computer 104 can be located outside the pendant 306 and can be electrically coupled to the camera 302 via the network or can be electrically coupled to the camera 302 without the network. The lasers 301 can be located inside the camera 302. The lasers 301 may comprise one lasers or more than one laser. Moreover, light-emitting diodes can be used instead of the lasers 301. The diffraction pattern generator 307 can be, for instance, a laser pattern generator. Laser pattern generators are diffractive optical elements with a very high diffraction efficiency. They can display any arbitrary patterns such as point array, arrow, cross, characters, and digits. Applications of laser pattern generators are laser pointers, laser diode modules, gun aimers, commercial display, alignments, and machine vision.

In an alternative embodiment of the image-capturing system 100 of FIG. 3, the pendant 306 may not comprise the filter 303, the half-silvered mirror 304, and the diffraction pattern generator 307. Moreover, alternatively, the lasers 301 can be located outside the pendant 306 such as, for instance, in a hat that the user 106 wears.

The camera 302 and the lasers 301 are preferably mounted at right angles to the diffraction pattern generator 307 which allows the laser light that the lasers 301 emit, to reflect a set of images 305 into the camera 302. This configuration allows the image-capturing system 100 of FIG. 3 to maintain depth invariance. Depth invariance means that regardless of the distance of the hand 201 from the camera 302, the one or many spots on the hand 201 appear at the same point on an image plane of the camera 302. The image plane is, for instance, the conversion device 107. The distance can be determined by the power of laser light that is reflected from the hand 201. The farther the hand 201 is from the camera 302, the narrower the set of angles at which the laser light that is reflected from the hand 201, will enter the camera 302, thereby resulting in a dimmer image of the hand 201. It should be noted that the camera 302, the lasers 301 and the beam splitter 307 can be at any angles relative to each other. However, a determination of a crossing of the hand and the laser light that the lasers 301 emit, becomes more difficult to ascertain.

The lasers 301 emit laser light that the beam splitter 307 splits to diverge the laser light. Part of the laser light that is diverged is reflected from the half-silvered mirror 304 to excite the atoms in the laser light. Part of the laser light is incident on the hand 201, reflected from the hand 201, and passes through the filter 303 into the camera 302. The camera 302 forms the set of images 305 of all or part of the hand 201. The conversion device 107 performs the same functionality on the set of images 210 as that performed on the set of images 105 of FIG. 1. Furthermore, the computer 104 performs the same functionality on data that corresponds to the set of images 305 as that performed by the computer 104 on data that corresponds to the set of images 105 of FIG. 1.

The laser light that the lasers 301 emit, is less susceptible to interference from ambient lighting conditions of an environment in which the user 106 is situated, and therefore the laser light is incident in the form of one or more spots on the hand 201. Furthermore, since the laser light that is incident on the hand 201, is intense and focused, the laser light that the hand 201 reflects, may be expected to produce a sharp and clear image in the set of images 305. The sharp and clear image is an image of the spots of the laser light on the hand 201. Moreover, the sharp and clear image is formed on the image plane. Additionally, the contrast of the spots on the hand 201 can be tracked, indicating whether or not the intensity of the lasers 301 as compared to the ambient lighting conditions is sufficient so that the hand 201 can be tracked, thus providing a feedback mechanism. Similarly, if light-emitting diodes that emit infrared light are used instead of the lasers 301, the contrast of the infrared light on the hand 201 indicates whether or not the user 106 is making gestures that the processor 112 can comprehend.

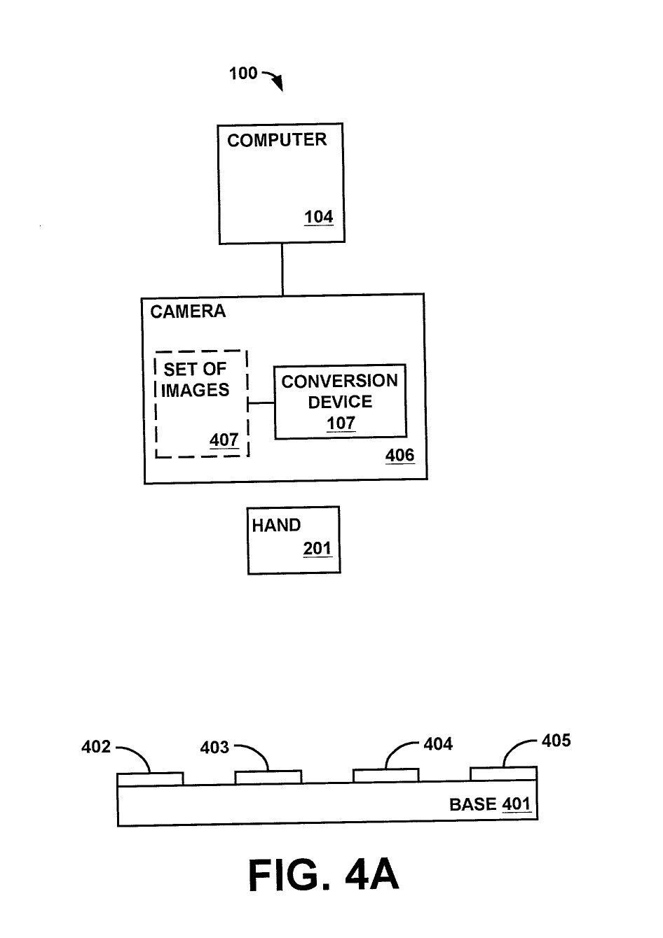

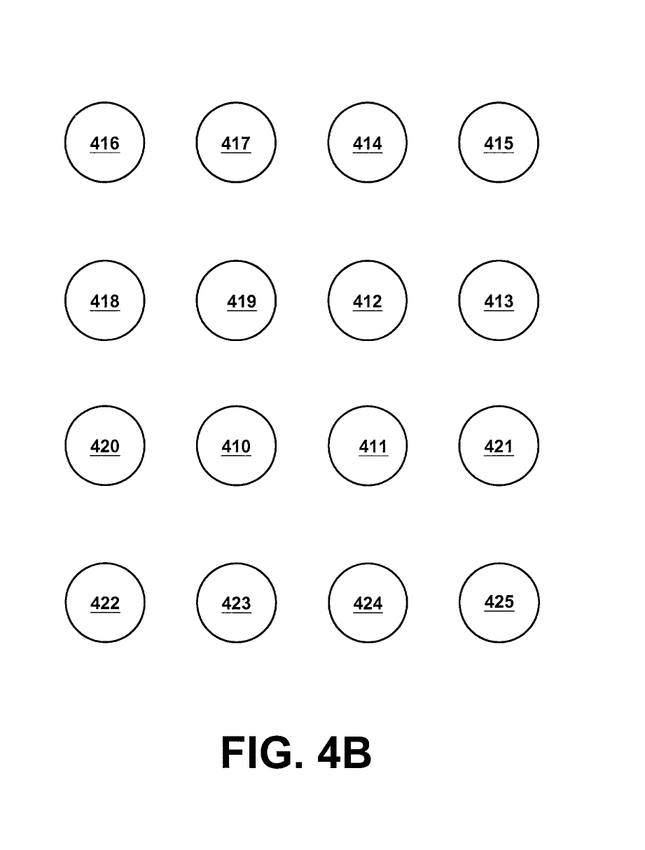

FIG. 4A is a block diagram of another embodiment of the image-capturing system 100 of FIG. 1. A base 401 comprises a series of light-emitting diodes 402-405 and a circuit (not shown) used to power the light-emitting diodes 402-405. Any number of lightemitting diodes can be used. The base 401 and the light-emitting diodes 402-405 can be placed in any location including, but not limited to a center console of a car, an armrest of a chair, a table, or on a wall. Moreover, the light-emitting diodes 402-405 emit infrared light. When the hand 201 or part of the hand 201 is placed in front of the light-emitting diodes 402-405, the hand 201 blocks or obscures the light from entering the camera 406 to form a set of images 407. The set of images 407 comprises one or more images, where each image is an image of all or part of the hand 201. The conversion device 107 performs the same functionality on the set of images 407 as that performed on the set of images 105 of FIG. 1. Furthermore, the computer 104 performs the same functionality on data that corresponds to the set of images 407 as that performed by the computer 104 on the data that corresponds to the set of images 105 of FIG. 1.

FIG. 4B is an image of the light-emitting diodes of the image-capturing system 100 of FIG. 4A. Each of the circles 410-425 represents an image of each of the light-emitting diodes of FIG. 4A. Although only four light-emitting diodes are shown in FIG. 4A, FIG. 4B assumes that there are sixteen light-emitting diodes in FIG. 4A. Furthermore, images 410-425 of each of the light-emitting diodes can be of any size or shape. The circles 410-415 are an image of the light-emitting diodes that the hand 201 obstructs. The circles 415-415 are an image of the light-emitting diodes that the hand 201 does not obstruct.

The image-capturing system 100 of FIGS. 1-4 is easier to use than the known command-and-control interfaces such as the remote control, the portable touch screen, the wall panel interface, and the phone interface since it does not comprise small, cryptic labels and can move with the user 106 as shown in FIGS. 1-2. Although the known command-and-control interfaces generally require dexterity, good eyesight, mobility, and memory, the image-capturing system 100 of FIGS. 1-4 can be used by those who have one or more disabilities.

Moreover, the image-capturing system 100 of FIGS. 1-4 is less intrusive than the speech recognition interface. For instance, the user 106 (FIGS. 1-3) can continue a dinner conversation and simultaneously make a gesture to lower or raise the level of light.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

What is claimed is:

1. An image-capturing system comprising:
a light-emitting device that emits light on an object;
an image-forming device that forms one or more images due to a light that is reflected from the object; and
a processor that analyzes motion of the object to control electrical devices,
wherein the light-emitting device and the image-forming device is configured to be portable.

2. The image-capturing system of claim 1, wherein the electrical devices comprise a light, a car stereo system, a radio, a television, a phone, a grill, a computer, a fan, a door, a window, a stereo, a refrigerator, an oven, a dishwasher, washers and dryers, answering machines, phones, a garage door, a hot plate, window blinds, night lights, doors, safe combinations, electric blankets, fax machines, printers, wheelchairs, adjustable beds, intercoms, chair lifts, jacuzzis, digital portraits, ATMs, faucets, freezers, cellular phones, microscopes, and electronic readers.

3. The image-capturing system of claim 1, wherein the processor processes data that corresponds to the one or more images to monitor various conditions of a user.

4. The image-capturing system of claim 3, wherein the various conditions of the user comprise tremors, parkinson's syndrome, insomnia, eating habits, alcoholism, over-medication, hypothermia and drinking habits, and wherein the user is one of a machine, a human being, a robot, and an animal.

5. The image-capturing system of claim 1, wherein the light-emitting device, the image-forming device, and the processor are comprised in one of a pendant, and a pin.

6. The image-capturing system of claim 1, wherein the light-emitting device is one of a plurality of light-emitting diodes, lasers, a tube light, and a plurality of bulbs.

7. The image-capturing system of claim 1, wherein the light emitted on the object is one of an infrared light, a laser light, a white light, a violet light, an indigo light, a blue light, a green light, a yellow light, an orange light, a red light, an ultraviolet light, microwaves, ultrasound waves, radio waves, X-rays, and cosmic rays.

8. The image-capturing system of claim 1, wherein the processor is configured to be portable.

9. The image-capturing system of claim 1, wherein the object is one of a hand, a finger, a paw, a pen, a pencil, and a leg.

10. The image-capturing system of claim 1, wherein a computer that comprises the processor is coupled to the image-forming device via a network.

11. The image-capturing system of claim 3, wherein the user makes different gestures to control each of the electrical devices.

12. The image-capturing system of claim 3, wherein the user speaks a name of one of the electrical devices and then makes a gesture to control the one of the electrical devices.

13. The image-capturing system of claim 3, wherein the user points its body to one of the electrical devices and makes a gesture to control the one of the electrical devices.

14. The image-capturing system of claim 3, wherein the user moves to a location in which one of the electrical devices is located and makes a gesture to control the one of the electrical devices.

15. The image-capturing system of claim 3, wherein the user points the light-emitting device to one of the electrical devices and makes a gesture to control the one of the electrical devices.

16. An image-capturing method comprising the steps of:
emitting light on an object;
forming one or more images of the object due to a light reflected from the object; and
processing data that corresponds to the one or more images of the object to control electrical devices, wherein the step of emitting light is performed by a light-emitting device that is configured to be portable, and the step of forming the one or more images of the object is performed by an image-forming device that is configured to be portable.

17. The image-capturing method of claim 16, wherein the electrical devices comprise a light, a car stereo system, a radio, a television, a phone, a grill, a computer, a fan, a door, a window, a stereo, a refrigerator, an oven, a dishwasher, washers and dryers, answering machines, phones, a garage door, a hot plate, window blinds, night lights, doors, safe combinations, electric blankets, fax machines, printers, wheelchairs, adjustable beds, intercoms, chair lifts, jacuzzis, digital portraits, ATMs, faucets, freezers, cellular phones, microscopes, and electronic readers.

18. The image-capturing method of claim 16, wherein a processor processes the data to monitor various conditions of a user.

19. The image-capturing method of claim 18, wherein the various conditions of the user comprise tremors, parkinson's syndrome, insomnia, alcoholism, over-medication, hypothermia, eating habits, drinking habits, and wherein the user is one of a human being, a robot, and an animal.

20. The image-capturing method of claim 16, wherein the steps of emitting, forming, and processing are performed in one of a pendant, and a pin.

21. The image-capturing method of claim 16, wherein the light-emitting device is one of a plurality of light-emitting diodes, lasers, a tube light, and a plurality of bulbs.

22. The image-capturing method of claim 16, wherein the light emitted on the object is one of an infrared light, a laser light, a white light, a violet light, an indigo light, a blue light, a green light, a yellow light, an orange light, a red light, an ultraviolet light, microwaves, ultrasound waves, radio waves, X-rays, and cosmic rays.

23. The image-capturing method of claim 16, wherein the step of processing is performed by a processor that is configured to be portable.

24. The image-capturing method of claim 16, wherein the object is one of a hand, a finger, a paw, a pen, a pencil, and a leg.

25. An image-capturing system comprising:
means for emitting light on an object;
means for forming one or more images of the object due to a light reflected from the object; and
means for processing data that corresponds to the one or more images of the object to control electrical devices, wherein the means for emitting light is configured to be portable and the means for forming the one or more images is configured to be portable.

26. The image-capturing system of claim 25, wherein the electrical devices comprise a light, a car stereo system, a radio, a television, a phone, a grill, a computer, a fan, a door, a window, a stereo, a refrigerator, an oven, a dishwasher, washers and dryers, answering machines, phones, a garage door, a hot plate, window blinds, night lights, doors, safe combinations, electric blankets, fax machines, printers, wheelchairs, adjustable beds, intercoms, chair lifts, jacuzzis, digital portraits, ATMs, faucets, freezers, cellular phones, microscopes, and electronic readers.

27. The image-capturing system of claim 25, wherein the means for processing processes the data to monitor various conditions of a user.

28. The image-capturing system of claim 27, wherein the various conditions of the user comprise tremors, parkinson's syndrome, insomnia, alcoholism, over-medication, hypothermia, eating habits, drinking habits, and wherein the user is one of a human being, a robot, and an animal.

29. The image-capturing system of claim 25, wherein the means for emitting, forming, and processing are comprised in one of a pin, and a pendant.

30. The image-capturing system of claim 25, wherein the light emitted on the object is one of an infrared light, a laser light, a white light, a violet light, an indigo light, a blue light, a green light, a yellow light, an orange light, a red light, an ultraviolet light, microwaves, ultrasound waves, radio waves, X-rays, and cosmic rays.

31. The image-capturing system of claim 25, wherein the means for processing is configured to be portable.
